(19) United States
(12) Patent Application Publication
(10) Pub. No.: US 2013/0190156 A1
(43) Pub. Date: Jul. 25, 2013

(54) FASTENING TOOL

(71) Applicant: PLUS CORPORATION, Tokyo (JP)

(72) Inventor: Takeshi MATSUKAWA, Tokyo (JP)

(73) Assignee: PLUS CORPORATION, Tokyo (JP)

(21) Appl. No.: 13/746,398

(22) Filed: Jan. 22, 2013

(30) Foreign Application Priority Data
Jan. 24, 2012 (JP) 2012-012518
Jun. 28, 2012 (JP) 2012-145395

(51) Int. Cl. B42F 3/00

(52) U.S. Cl. CPC B42F 3/003
USPC 493/351

(57) ABSTRACT

A fastening tool can be held by a single hand and can obviate the necessity of application of strong force when fastening sheets of paper together. The fastening tool has a construction in which a placing table configured to move only in a vertical direction is provided at an inner upper portion of a base member, a paper holding member configured to move in a vertical direction is disposed above the placing table, a handle member is mounted on the base member so as to rotate relative thereto about a position lying near a rear end thereof, and a portion of the handle member which lies inside and further rearwards than a central portion of the handle member is formed into a pressing portion, whereby an upper surface of a rear portion of the paper holding member is pressed down directly by the pressing portion.

### CROSS-REFERENCE TO RELATED APPLICATIONS

This application is based upon and claims the benefit of priority under 35 USC 119 of Japanese Patent Application No. 2012-012518 filed on Jan. 24, 2012, and Japanese Patent Application No. 2012-145395 filed on Jun. 28, 2012, the entire contents of which, including the descriptions, claims, drawings and abstracts, are incorporated herein by reference.

### FIELD

The present invention relates to a fastening tool referred to as a paper stapler and used to fasten sheets of paper without using a metallic staple or staples.

### BACKGROUND

In these days, as stationery, many fastening tools called staplers are used to fasten sheets of paper by driving a metallic staple or staples into the sheets of paper.

In recent years, however, it is getting important more and more to prevent the destruction of the natural environment by saving natural resources, for example, by recycling waste paper. For example, as described in JP-A-08-300865 and JP-A-2010-137751, staplers using no metallic staples have been proposed, and such staples using no metallic staples have also been put to practical use.

The staplers that use no metallic staples are fastening tools for fastening sheets of paper by forming pieces of tongue-shaped paper from superposed sheets of paper by punching them out, forming linear cuts which are something like a straight line in the superposed sheets of paper in a position lying near base portions of the pieces of tongue-shaped paper, folding back the pieces of tongue-shaped paper formed in the superposed sheets of paper at the base portions while keeping them in the superposed state and inserting free distal ends of the superposed pieces of tongue-shaped paper into the linear cuts so that the superposed pieces of tongue-shaped paper are maintained in the folded-back state to thereby prevent the separation of the superposed sheets of paper.

In this way, in paper staplers, sheets of paper are maintained in a superposed state by folding back portions of the sheets of paper to be fastened together without using a metallic staple or staples, and therefore, the paper staplers are the fastening tool which is advantageous in that it is possible to realize the saving of natural resources. In addition, when materials prepared by fastening sheets of paper with using the paper stapler are disposed of, since no metallic staples are used, the separation of metallic staples from the sheets of paper becomes unnecessary. Thus, the paper staplers are the fastening tool which is advantageous in that the disposing of such materials can be facilitated.

However, in the paper staplers, since the portions of the superposed sheets of paper are punched out and are then folded back, in the event that the handle of the paper stapler is not pressed down sufficiently, the pieces of punched out paper cannot be folded back sufficiently, and hence, the superposed sheets of paper cannot be fastened together in an ensured fashion. Additionally, since the handle needs to be pressed down securely and strongly against the repulsive force of the elastic member, in order to fasten the sheets of paper, the handle has to be pressed down strongly, leading to an inconvenience to use the paper stapler.

### SUMMARY

The invention has been made with a view to solving the problem inherent in the paper staplers according to the related art and an object thereof is to provide a paper stapler as a fastening tool that can solve the problem and which can be held in one hand for use in fastening sheets of paper with no strong force being applied thereto.

According to an aspect of the invention, there is provided a fastening tool having a first cutter for forming pieces of tongue-shaped paper in sheets of paper and a second cutter for forming linear cuts in the sheets of paper, in which the pieces of tongue-shaped paper are formed through U-shaped cut lines by the first cutter and the linear cuts are formed near base portions of the pieces of tongue-shaped paper by the second cutter, and the pieces of tongue-shaped paper are folded back so that distal ends of the pieces of tongue-shaped paper are inserted into the linear cuts to fasten the sheets of paper that are superposed one on the other or another, the fastening tool comprising: a base member having a wall portion which is raised from a periphery of a bottom plate having a flat plate shape; a handle member which is mounted on a rear upper portion of the base member so as to rotate about a position lying near a rear end thereof; and a placing table configured so as to slide vertically and which is provided at an inner upper portion of the base member, wherein the first cutter and the second cutter are accommodated below the placing table; a paper holding member configured so as to slide vertically and which is provided above the placing table, wherein an upper surface of a portion of the paper holding member which lies near a rear end thereof is pressed down by a portion of the handle member which lies inside and further rearwards than a center of the handle member so as to lower the paper holding member; wherein sheets of paper held between the placing table and the paper holding member are lowered together with the paper holding member and the placing table so that cuts are provided in the sheets of paper so held by the first cutter and the second cutter to thereby fasten the sheets of paper together.

Additionally, in the fastening tool, the base member and the handle member, the placing table and the paper holding member are formed of resin and a metallic plate having a plate shape is provided in an interior of the handle member.

In the fastening tool according to the aspect of the invention, as has been described above, the placing table is disposed at the inner upper portion of the base member. The paper holding member is disposed above the placing table. The handle member is mounted on the base member so as to rotate about the position lying near the rear end thereof, and the portion of the handle member lying further rearwards than the center thereof is formed into the pressing portion to thereby form a cam construction. Therefore, the paper holding member and the placing table can be lowered with a small force. Further, the fastening tool can be made relatively simple in construction and hence can be fabricated with ease.

In addition, in the fastening tool, the base member and the handle member, the placing table, and the paper holding member are formed of resin. Thus, the fastening tool can be made light in weight and hence can be handled easily by a single hand.

### BRIEF DESCRIPTION OF THE DRAWINGS

FIG. 1 is a front perspective view depicting one embodiment of a fastening tool according to the invention.

FIG. 2 is a side view depicting a state in which the fastening tool according to the invention is opened.

FIG. 3 is a side view depicting a state in which the fastening tool according to the invention is closed.

FIG. 4 is a schematic diagram depicting a state in which pieces of tongue-shaped paper and linear cuts are formed in sheets of paper by the fastening tool according to the invention.

FIGS. 5A and 5B show a plan view and a sectional view which depict a state in which the pieces of tongue-shaped paper formed by the fastening tool according to the invention are folded back.

FIGS. 6A and 6B show a perspective view and a side view which depict a part of constituent elements of a handle member of the fastening tool according to the invention.

FIG. 7 is an exploded view depicting exemplarily constituent elements of the fastening tool according to the invention.

FIG. 8 is a side view depicting exemplarily the constituent elements of the fastening tool according to the invention.

FIG. 9 is a side view depicting exemplarily an operation of the fastening tool according to the invention.

FIG. 10 is a side view depicting exemplarily an operation of the fastening tool according to the invention.

FIG. 11 is a side sectional view depicting a state in which the fastening tool according to the invention is opened.

FIG. 12 is a side view of cutter members of the fastening tool according to the invention.

FIG. 13 is a perspective view of the cutter members of the fastening tool according to the invention.

FIG. 14 is a side sectional view depicting a state in which the fastening tool according to the invention is closed.

FIG. 15 is a perspective view depicting an operating state of the cutter members of the fastening tool according to the invention.

FIG. 16 is a sectional view depicting a connecting portion of the fastening tool according to the invention.

FIGS. 17A and 17B show sectional views depicting an operation of the connecting portion of the fastening tool according to the invention.

### DETAILED DESCRIPTION

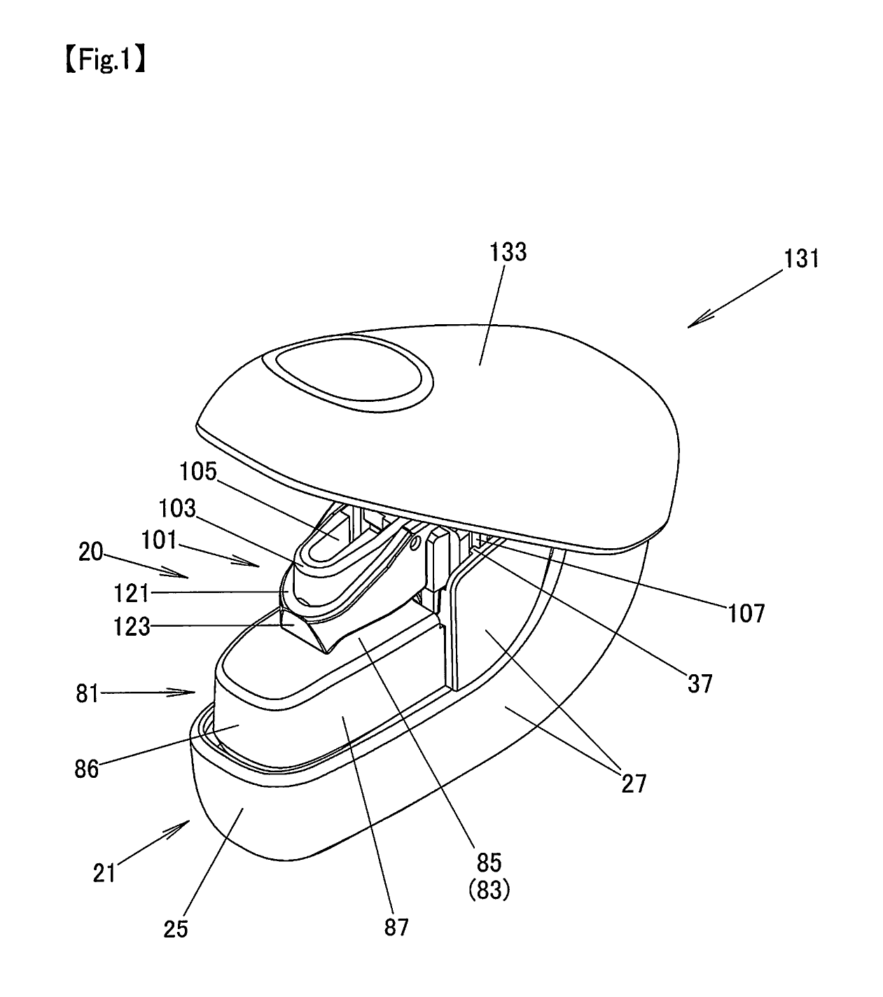

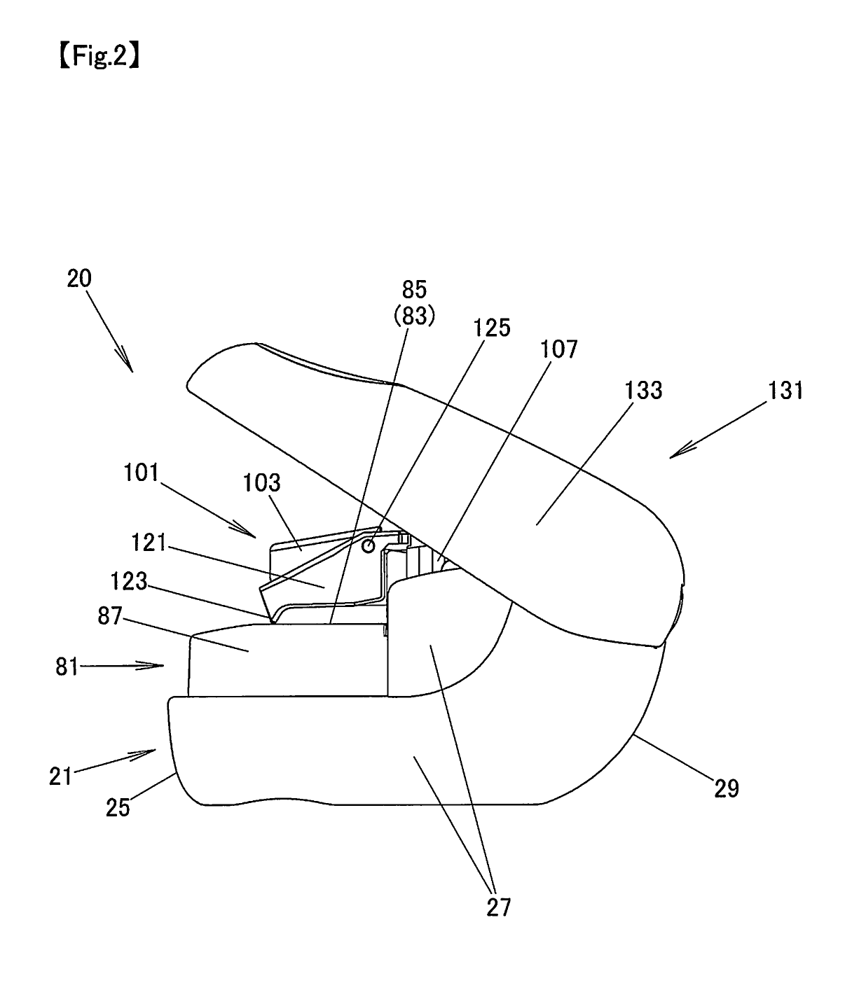

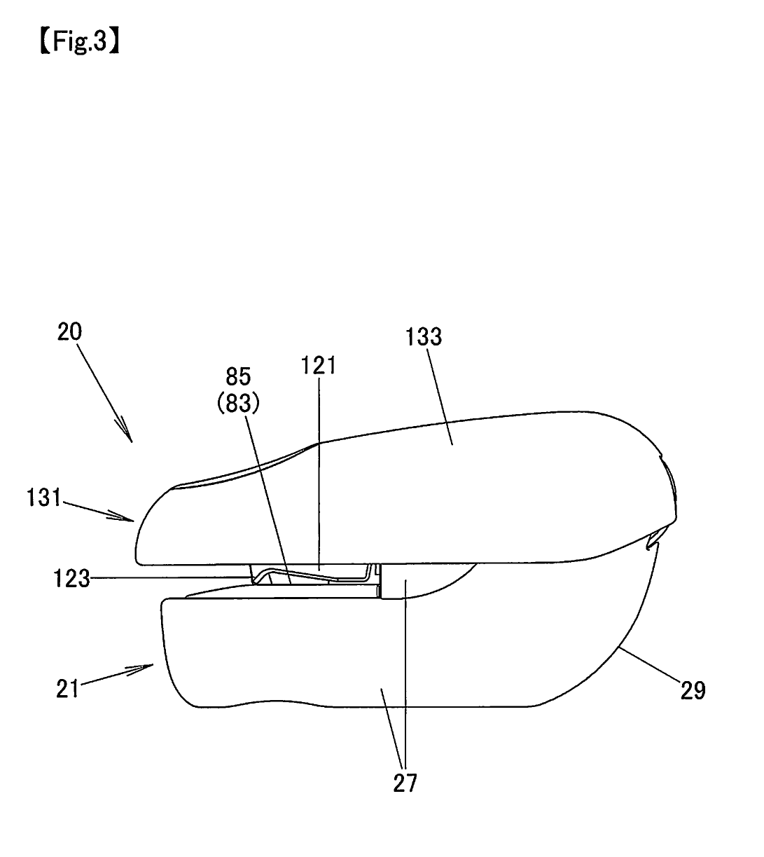

A fastening tool according to an aspect of the invention is called a paper stapler and has, as shown in FIGS. 1 and 2, a placing table 81 and a paper holding member 101, which are provided between a handle member 131 which rotates about a rear portion thereof and a base member 21. The fastening tool 20 according to the aspect of the invention can be held with one hand. When a front end of the handle member 131 is lowered so as to approach the base member 21 as shown in FIG. 3 while being so held, the paper holding member 101 is lowered, and the placing table 81 is lowered so as to be accommodated in the base member 21, whereby sheets of paper can be fastened together.

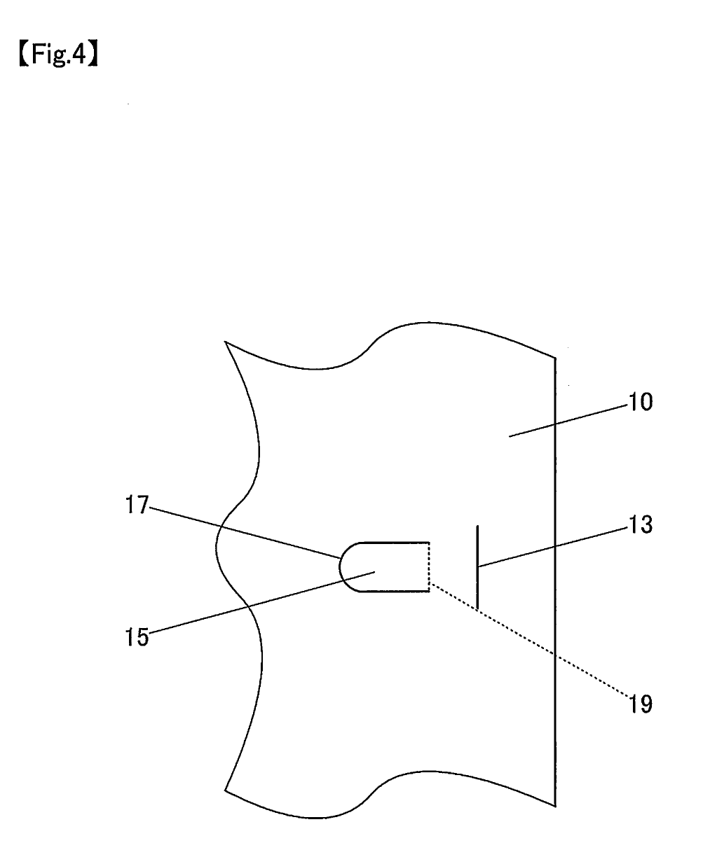

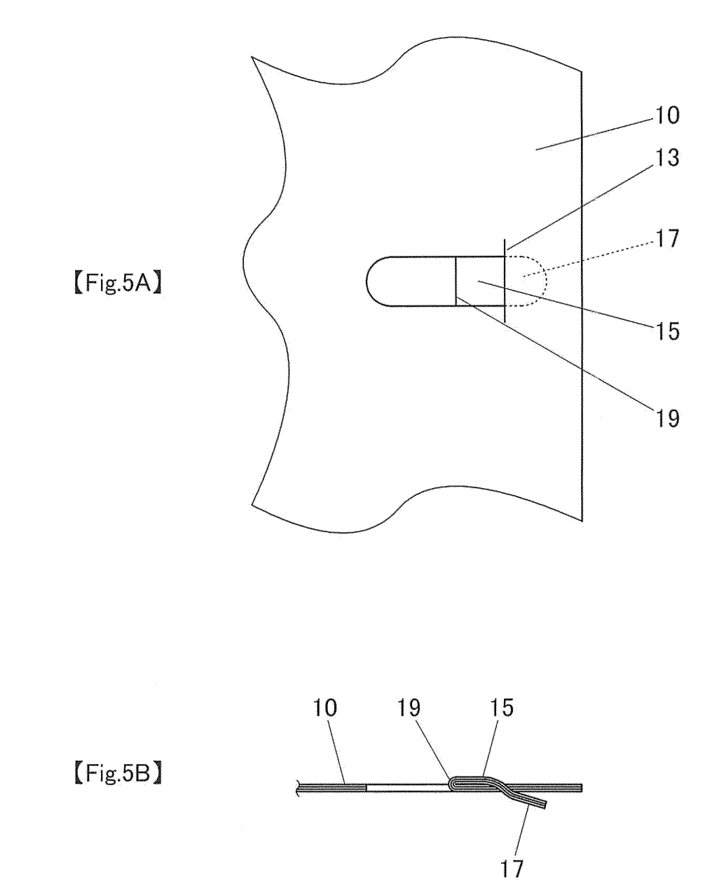

In this fastening tool 20, when the front end of the handle 131 is lowered, as shown in FIG. 4, U-shaped cuts are made in sheets of paper 10 which are inserted between the placing table 81 and the paper folding member 101 to form therein pieces of tongue-shaped paper 15 near an end portion of the sheets of paper 10. Additionally, linear cuts 13 which are something like a straight line are formed in the sheets of paper 10 near base portions 19 of the pieces of tongue-shaped paper 15. Then, as shown in FIG. 5, the pieces of tongue-shaped paper 15 are folded back at the base portions 19 so that distal ends 17 of the pieces of tongue-shaped paper 15 are inserted into the linear cuts 13, whereby the sheets of paper 10 that are superposed one on the other or another are fastened together.

It should be noted that the description of the fastening tool 20 will be made based on the understanding that positional relationships exist between the constituent members of the fastening tool 20 shown in FIG. 1 as follows. As to a vertical direction, the handle member 131 is placed upwards of the base member 21 or the base member 21 is placed downwards of the handle member 131. As to a front-to-rear or longitudinal direction, the handle member 131 and the base member 21 are connected together at rear portions thereof, and the handle member 131 and the base member 21 are opened or closed at front ends thereof Additionally, when a bottom surface of the base member 21 is assumed as a horizontal plane, a horizontal direction that intersects transversely at right angles to the front-to-rear direction of the horizontal plane will be referred to as a left-to-right or transverse direction.

In addition, the summary of the invention will be described by reference to the drawings before an embodiment of the invention will be described in detail.

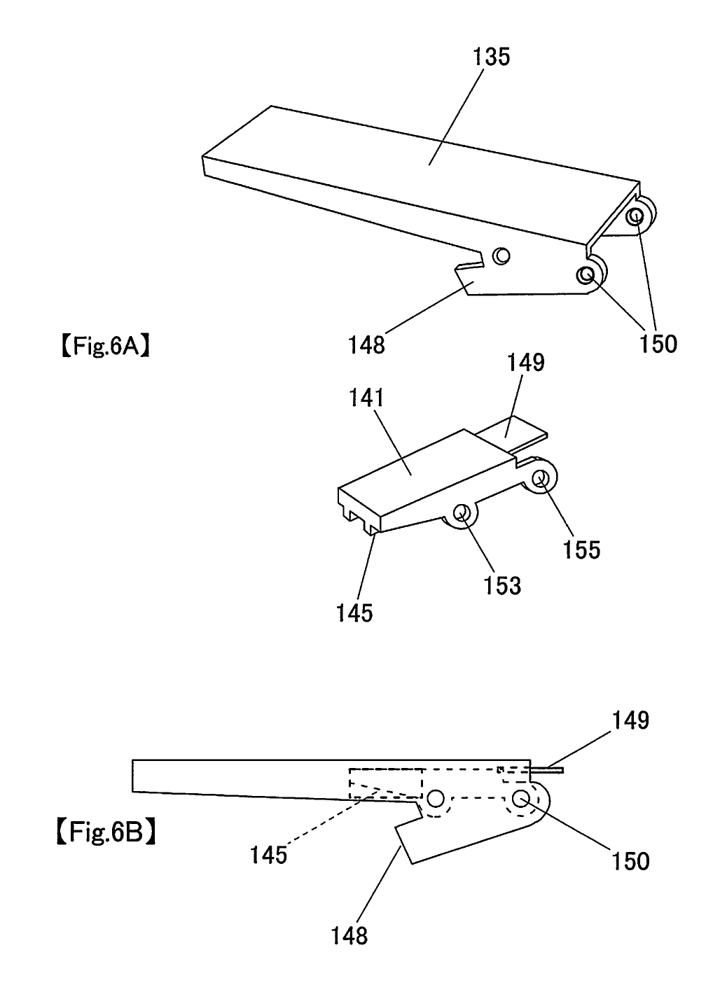

FIG. 6 depicts a handle plate 135 which is incorporated in the handle member 131 of the invention and a base member 141 which is disposed at a rear end of the handle member 135.

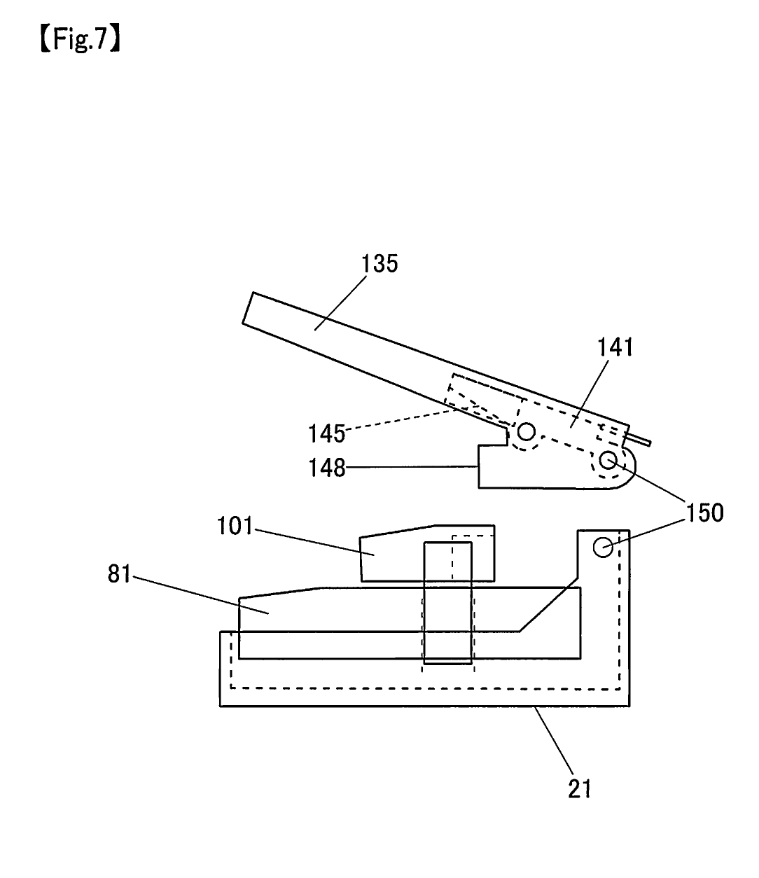

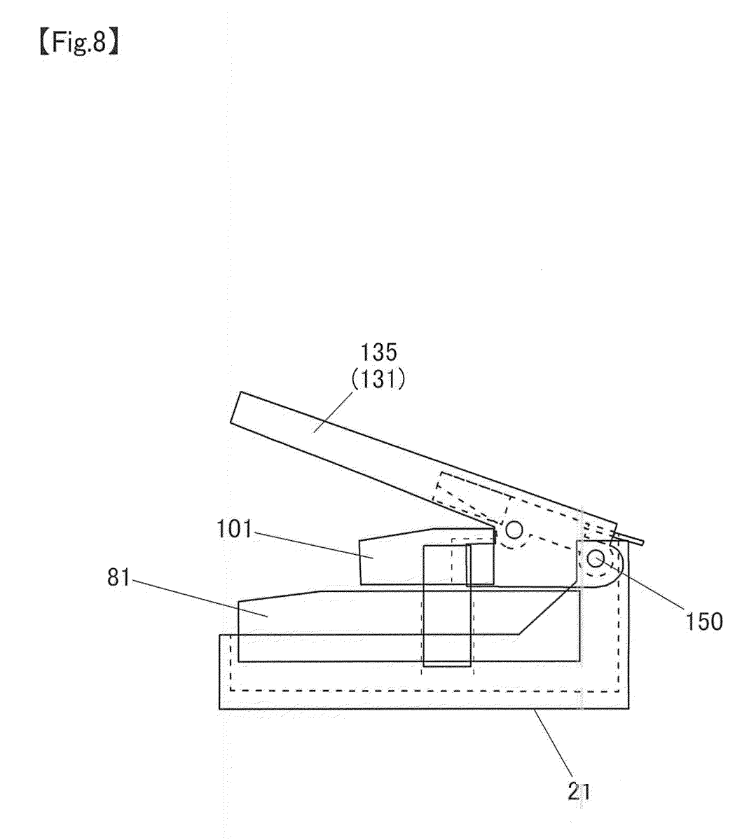

Additionally, FIGS. 7 and 8 depict exemplarily a state resulting before the handle plate 135 to which the base member 141 is fixed is fixed to the base member 21 and a state resulting after the handle member 135 is fixed to the base member 21, respectively.

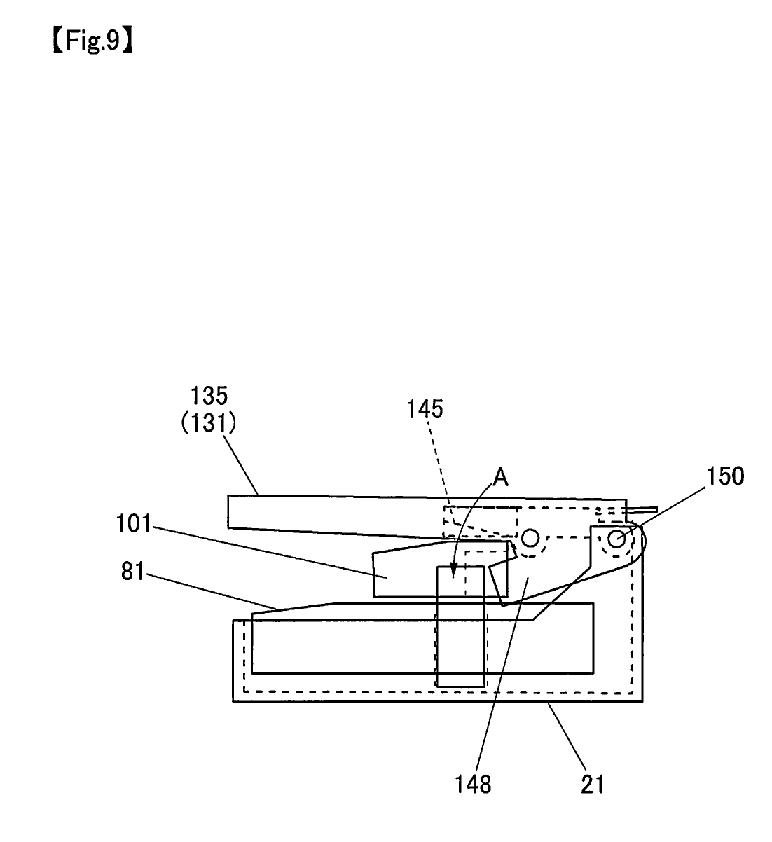

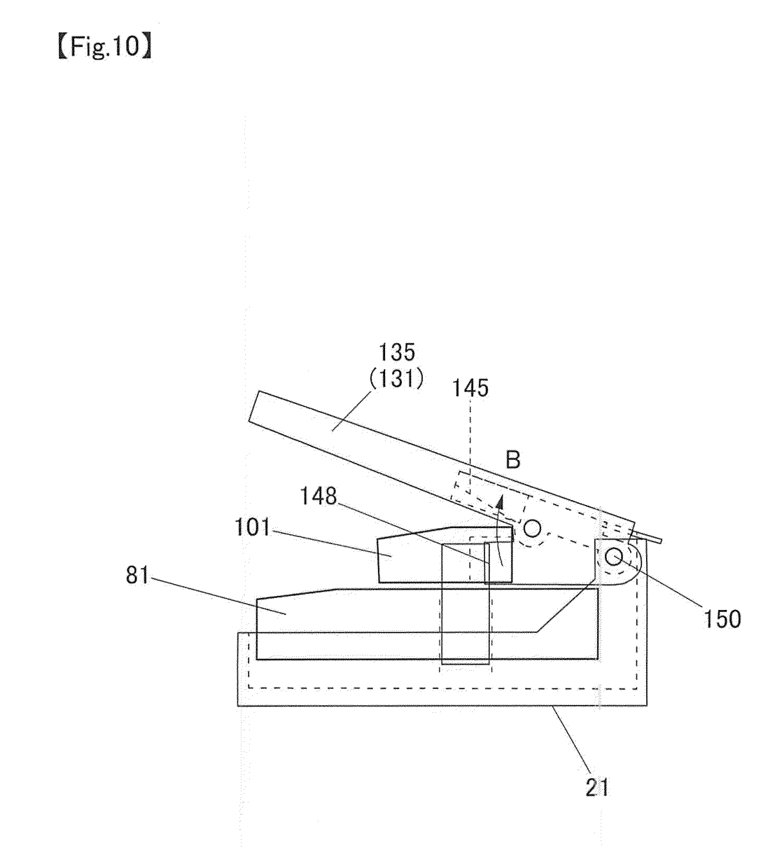

Further, FIG. 9 depicts a state in which the handle member 131 in which the handle plate 135 is incorporated is pressed down to start a paper fastening operation, and FIG. 10 depicts a state in which the handle member 131 is pulled up from such a press-locked state that the handle member 131 is pressed down and is then locked by a paper jamming in the pressed state.

Opening portions 150 are provided at the rear end of the handle plate 135 for a handle shaft with which the handle plate 135 is fixed rotatably to the base member 21.

Additionally, projecting portions 148 are also provided on the handle plate 135 for engagement with slits which are provided in the paper holding member 101.

Openings 153 and openings 155 are provided in the base member 141. The openings 153 are used to fix the base member 141 to the handle plate 135 when the base member 141 is placed upon the handle plate 135 as shown in FIG. 6B. A handle shaft 137 is inserted in the openings 155.

Additionally, a pressing portion 145 is provided on the base member 141 to press and slide the paper holding member 101.

Further, a tensioning plate spring 149 is provided on the base member 141. A force from the base member 21 is applied to this plate spring 149 to thereby obtain a force that tends to press down a front end of the handle plate 135 without wobbling.

When the handle member 131 in which the handle plate 135 is incorporated is pressed down, a force indicated by an arrow A is applied as shown in FIG. 9, and a cam construction works in which the paper holding member 101 is pressed down by the pressing portion 145 of the base member 141 which is mounted in the handle member 131 which rotates, whereby the paper holding member 101 is lowered together with the placing table 81, whereupon a paper fastening operation, not shown, is started.

In this invention, by the configuration that has been described heretofore, the handle member 131 is allowed to be linked with the paper holding member 101 by the cam construction without using a metallic link member. Thus, the number of metallic parts to be used can be decreased, and a load to be applied to the handle member 131 can also be reduced as when the metallic link member is used.

In addition, even in the event that the handle member 131 is locked in the state in which the handle member 131 is pressed down due to too many sheets of paper having to be fastened together, since the projecting portions 148 are provided on the handle plate 135, it is possible to pull up the paper holding member 101 from the pressed-down state by a force indicated by an arrow B as shown in FIG. 10 which is caused by pulling up the handle member 131.

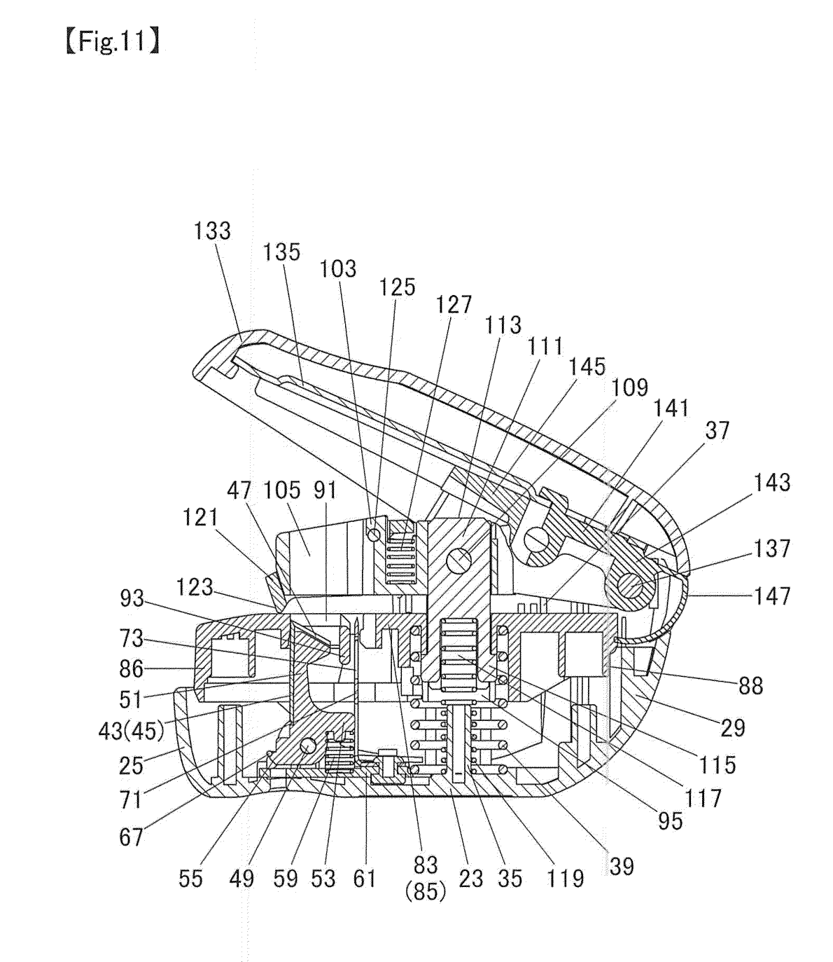

Then, the construction of the fastening tool 20 will be described in detail. As shown in FIG. 11, a first cutter 43, a second cutter 71, a first elastic member 39 and a second elastic member 119 are accommodated in an interior of the base member 21. The first cutter 43 forms pieces of tongue-shaped paper in sheets of paper, and the second cutter 71 forms linear cuts in the sheets of paper. The first elastic member 39 pushes up the placing table 81, and the second elastic member 119 pushes up the paper holding member 101.

It should be noted that the springback force of the first elastic member 39 is set larger than the springback force of the second elastic member 119.

The base member 21 has a bottom plate 23 formed into a flat plate shape, a front wall portion 25 which extends upwards from a front end of the bottom plate 23, side wall portions 27 which are contiguous with left and right ends of the front wall portion 25 and which extend upwards from left and right side edge portions of the bottom plate 23 and a rear wall portion 29 that is contiguous with rear ends for the side wall portions 27 and which extend rearwards and upwards from a rear end of the bottom plate 23.

Additionally, in each side wall portion 27, as shown in FIGS. 1 and 2, a rear half portion which lies further rearwards than a central portion is formed taller than a front half portion, and a sliding projecting portion 37 is provided on an inner side of the rear half portion so as to extend vertically into a straight line. Additionally, a handle shaft hole where the handle shaft 137 is fixed in place is provided in a position lying near a rear upper end of the side wall portion 27.

The first cutter 43 and the second cutter 71 are provided inside the base member 21, and a strut portion 35 formed into a cylindrical shape is provided at the rear of the second cutter 71 so as to be erected from the base member 21. Then, the first elastic member 39 which is configured to push up the placing table 81 is provided concentrically with an axis of the strut portion 35, and the second elastic member 119 which is configured to push up the paper holding member 101 is also provided concentrically with the axis of the strut portion 35 inside the first elastic member 39.

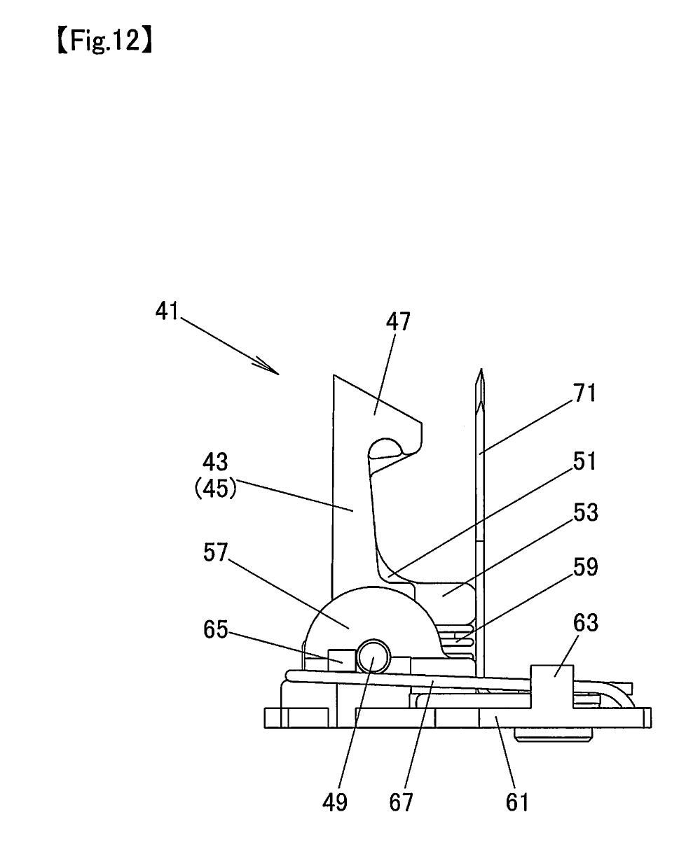

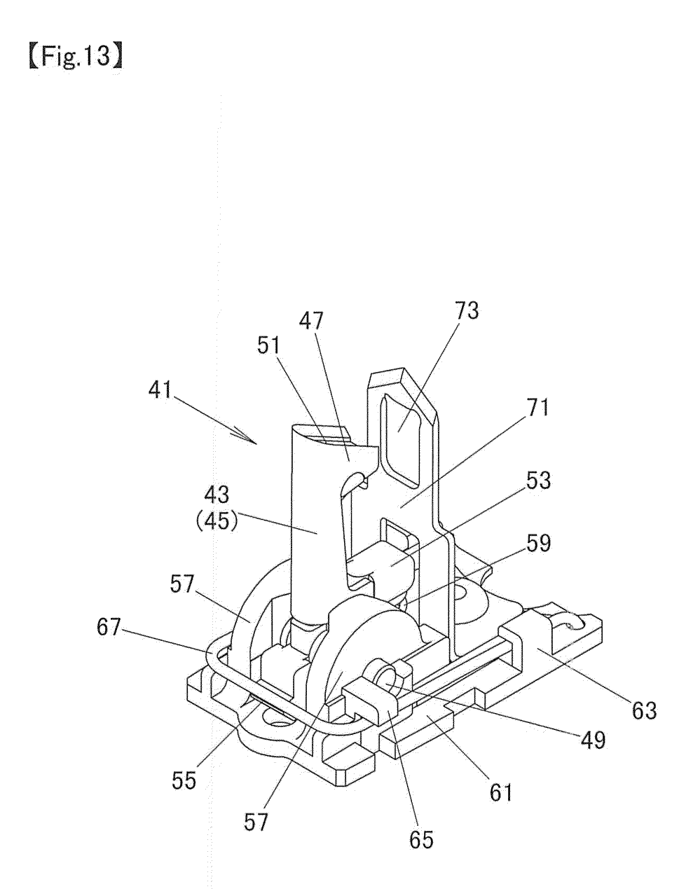

As shown in FIGS. 12 and 13, the first cutter 43 and the second cutter 71 are fixed to a base plate portion 61, and the first cutter 43 and the second cutter 71 are configured to work as a pair to make up a cutter member 41. In the cutter member 41, the second cutter 71 is provided in a substantially central position of the base plate portion 61 so as to be erected vertically therefrom, and the first cutter 43 is mounted on the base plate portion 61 in a position lying near a front end thereof so as to be erected vertically relative to the base plate portion 61.

The first cutter 43 has a distal projection 47 which projects to the rear at an upper end of a main body portion 45 and is formed into a U-shape which is opened at the rear thereof Upper end edges of the main body portion 45 and the distal projection 47 are formed into a blade portion. A bending member 51 is provided inside the main body portion 45 so as to be integral with the first cutter 43. This bending member 51 has substantially the same shape as that of the first cutter 43 and is made slightly smaller in size than the first cutter 43.

The first cutter 43 and the bending member 51 are mounted on the base plate portion 61 by a cutter shaft 49 in such a manner that lower ends thereof are positioned between cutter support portions 57 which are provided on an upper surface of the base plate portion 61 so as to project therefrom and are made to rotate relative to the base plate portion 61 about the cutter shaft 49 which is positioned near the lower ends of the first cutter 43 and the bent portion 51. A proximal projection 53 is provided on the bending member 51 so as to project to the rear from a position lying near the lower end of the bending member 51. This proximal projection 53 is made to project more to the rear than the distal projection 47, and a return spring 59 is provided between the proximal projection 53 and the base plate portion 61, whereby the bending member 51 and the first cutter 43, which are made integral with each other, are erected substantially vertically while upper ends of the bending member 51 and the first cutter 43 are biased to the front.

Additionally, the cutter member 41 has a sound generating spring 67. This sound generating spring 67 has a front straight-line portion and side straight-line portions which extend from both ends of the front straight-line portion as far as near a rear end of the base plate portion 61 and hence is formed into a U-shape. The front straight-line portion and the side straight-line portions are disposed along a circumferential edge of the base plate portion 61 and above the base plate portion 61. The sound generating spring 67 is fixed to the base plate portion 61 by spring fixing portions 63 in positions on the side straight-line portions which lie near rear ends thereof Thus, the sound generating spring 67 is fixed to the base plate portion 61 in such a state that the whole of the sound generating spring 67 is spaced apart slightly from the upper surface of the base plate portion 61.

Further, spring restricting portions 65 are provided on outer sides of the left and right cutter support portions 57 which project upwards from the upper surface of the base plate portion 61, and the spring restricting portions 65 project leftwards and rightwards from the corresponding cutter support portions 57. Then, the spring restricting portions 65 are positioned near front ends and above the side straight-line portions of the sound generating springs to restrict a front portion of the sound generating spring 67 such as the front straight-line portion from being spaced a predetermined distance or more apart from the upper surface of the base plate portion.

Additionally, a front protuberant portion 55 is provided at a lower end portion of the bending member 51. This front protuberant portion 55 slightly protrudes to the front from a position lying near the lower end of the bending member 51 to be brought into contact with a lower side of the front straight-line portion of the sound generating spring 67. Then, when the bending member 51 rotates to the rear at an upper end thereof together with the first cutter 43, the front protuberant portion 55 raises slightly the front straight-line portion of the sound generating spring 67. Then, when the front straight-line portion is raised, the engagement between the front straight-line portion of the sound generating spring 67 and the front protuberant portion 55 is released.

In addition, the second cutter 71 is formed into a flat plate-like shape and is substantially as tall as the first cutter 43. An upper end edge of the second cutter 71 is made into a blade portion, and a window portion 73 is provided in the second cutter 71 near an upper end thereof for insertion of a rear end portion of the distal projection 47, when the first cutter 43 rotates.

Additionally, as shown in FIGS. 1, 2 and 11, the placing table 81 has a flat plate member 83 formed into a flat plate-like shape. The flat plate member 83 has a flat portion 85 that is slightly inclined downwards at part of a front portion and is horizontally flat from a central portion to a rear portion thereof The placing table 81 then has a front suspended wall 86, side suspended walls 87 and a rear suspended wall 88 which are suspended vertically from the periphery of the flat plate member 83. Respective heights of the suspended walls 86, 87, 88 are substantially the same as the height of the front wall portion 25 of the base member 21. The placing table 81 is sized so that the placing table 81 is allowed to be accommodated in the base member 21 having the wall portions made up of the front wall portion 25, the side wall portions 27 and the rear wall portion 29.

In addition, vertical straight-line sliding grooves are provided on outer surfaces of rear half portions of the left and right side suspended walls 87, so that the sliding projections 37 are placed in the corresponding sliding grooves in an engaging fashion which are formed on the inner sides of the rear half portions of the side wall portions 27 of the base member 21 which are taller than the front half portions thereof In this configuration, the placing table 81 is allowed to slide only in a vertical direction relative to the base member 21, and an upward movement limit position of the placing table 81 is determined by lower ends of the sliding grooves.

An opening portion 91 is provided in the front portion of the flat portion 85 in a position which corresponds to the first cutter 43 and the second cutter 71, so that when the placing table 81 is lowered, the upper ends of the first cutter 43 and the second cutter 71 are allowed to project upwards of the flat portion 85, and when the placing table 81 is stopped to stay in an upper end position thereof, the upper end of the first cutter 43 is allowed to be in contact with an inner side of a front end portion of the opening portion 91 so that the first cutter 43 can be held in a vertical state. In addition, a pressing-down portion 93 is provided in an interior of the opening portion 91 in a position lying above the proximal projection 53 of the first cutter 43. This pressing-down portion 93 is formed into a plate-like shape and is fixed to the left and right side suspended walls 87 at both ends thereof.

Further, a sliding hole is provided in the flat portion 85 at the rear of the opening portion 91 so as to allow a sliding shaft 111 which is suspended vertically from the paper holding member 101 to penetrate therethrough. Then, a spring bearing portion 95 is formed so as to surround the sliding hole, and the first elastic member 39 is disposed between the placing table 81 and the bottom plate 23 of the base member 21, whereby the placing table 81 is biased upwards so as to be spaced apart from the base member 21.

The paper holding member 101 has a thick main body portion 103 having a bottom surface which is slightly smaller than the flat portion 85 of the placing table 81. In the paper holding member 101, a sliding shaft hole is provided near a rear end of the main body portion 103 so as to allow the sliding shaft 111 to penetrate therethrough in a vertical direction. Then, the sliding shaft 111 is press fitted in the sliding shaft hole in such a manner that an upper end face 113 of the sliding shaft 111 is exposed to an upper surface of a rear portion of the main body portion 103, and the sliding shaft 111 is fixed to the main body portion 103 of the paper holding member 101 by a fixing shaft 109.

The sliding shaft 111 has a collar portion 115 which expands radially outwards at a lower end thereof, so as to prevent an upward dislodgement of the sliding shaft 111 from the sliding hole in the placing table 81. Additionally, a shaft receiving hole 117 is provided in a center of a lower end of the sliding shaft 111 so as to extend upwards substantially to a vertical center thereof Then, an upper portion of the second elastic member 119 is inserted into the shaft receiving hole 117, while a lower end of the second elastic member 119 is fixed to the upper surface of the bottom plate 23 of the base member 21, whereby the paper holding member 101 is biased upwards by the second elastic member 119.

Upper sliding grooves 107 are provided in outer surfaces of the rear portion of the main body portion 103 of the paper holding member 101, so that the sliding projections 37 provided on the inner surfaces of the side wall portions 27 of the base member 21 are inserted therein (refer to FIGS. 1 and 2), whereby the paper holding member 101 is allowed to move only in a vertical direction relative to the base member 21 together with the sliding shaft 111.

In addition, an open hole portion 105, which is sized to match the opening portion 91 in the placing table 81, is provided in a front portion of the main body portion 103 of the paper holding member 101, so that when the paper holding member 101 is lowered, distal end portions of the first cutter 43 and the second cutter 71 can be accommodated therein.

Further, the paper holding member 101 has a substantially U-shaped movable member 121 which can cover a front half portion of the main body portion 103. A distal end portion 123 at the front of the movable member 121 projects slightly downwards so as to conceal a front of the opening portion 91 of the placing table 81. This movable member 121 is fixed to an upper portion of the main body portion 103 by a rod-shaped swing shaft 125 at a rear upper portion thereof in a swinging fashion, and a portion of the movable member 121 which lies further rearwards than the swing shaft 125 is biased upwards by a swing spring 127, whereby the distal end portion 123 is brought into contact with the flat portion 85 of the placing table 81.

The handle member 131 has a handle cover 133, the handle plate 135 which is provided inside the handle cover 133 and the base member 141, and the rigidity of the handle member 131 is ensured by the handle plate 135 that is a flat-shaped metallic plate and which is provided in an interior of the handle cover 133 having an elliptic semi-spherical shape.

The resin base member 141 is provided on a lower surface of a rear half portion of the handle plate 135, and bearing portions 143 are provided at a rear end of the base member 141. Then, the handle shaft 137 which penetrates the bearing portions 143 transversely is inserted in handle shaft holes in the base member 21 at both ends thereof, whereby the front end of the handle member 131 is allowed to rotate vertically relative to the base member 21 about the handle shaft 137.

Further, the pressing portion 145 is formed on a lower surface of a front portion of the base member 141 and is positioned above the sliding shaft 111. When the front end of the handle member 131 is lowered, the upper end face 113 of the sliding shaft 111 is pressed down by the pressing portion 145 which is positioned further rearwards than the center of the handle member 131 inside this handle member 131, whereby the paper holding member 101 is lowered.

The base member 141 has an elastic portion 147 which extends downwards from a rear end of the base member 141. This elastic portion 147 is formed into a plate shape and is curved into an arc shape. The elastic portion 147 projects downwards from the rear end of the base member 141 so as to generate elastic force as a result of a plastic deformation of the resin base member 141. A distal end of the elastic portion 147 is positioned on an inner side of an upper end of the rear wall portion 29 and is brought into sliding contact with the upper end of the rear wall portion 29 of the base member 21 so as to bias slightly to open the front end of the handle member 131 upwards.

In the handle member 131, when rear ends of sides of the handle cover 133 are brought into contact with rear upper ends of the side wall portions 27 of the base member 21, the pressing portion 145 of the base member 141 is positioned slightly spaced apart from the upper end face 113 of the sliding shaft 111, and the front end of the handle member 131 is prevented from rotating further upwards than this state.

Consequently, in this fastening tool 20, sheets of paper 10 are inserted between the placing table 81 and the paper holding member 101 in such a manner as to press open the distal end portion 123 of the movable member 121 which is in contact with the upper surface of the flat portion 85 to thereby be held thereat. Then, when the fastening member 20 is held strongly in one hand so that the front end of the handle member 131 approaches the base member 21, the front end of the handle member 131 is lowered, whereby the upper end face 113 of the sliding shaft 111 can be pressed downwards by the pressing portion 145.

Then, since the springback force of the second elastic member 119 is set smaller than the springback force of the first elastic member 39, the sheets of paper 10 which are inserted between the placing table 81 and the paper holding member 101 can be fixedly held by the main body portion 103 and the flat portion 85 therebetween as a result of the paper holding member 101 being lowered, and the sheets of paper 10 so held can be lowered together with the placing table 81 in synchronism with the lowering of the paper holding member 101.

In this way, when the sheets of paper 10 are lowered together with the placing table 81 and the paper holding member 101, whereby an upper surface of the placing table 81 becomes lower than the upper ends of the first cutter 43 and the second cutter 71, U-shaped cut lines are formed in the sheets of paper 10 by the blade portion of the first cutter 43 and linear cuts 13 are formed in the sheets of paper 10 by the second cutter 72.

Then, when the front end of the handle member 131 is lowered and the upper ends of the first cutter 43 and the second cutter 71 penetrate the sheets of paper 10 to be inserted into the open hole portion 105 in the paper holding member 101, pieces of tongue-shaped paper 15 that are formed by the U-shaped cut lines made by the first cutter 43 to lie inside the cut lines are pushed up into an erected state by the bending member 51 that is made integral with the first cutter 43.

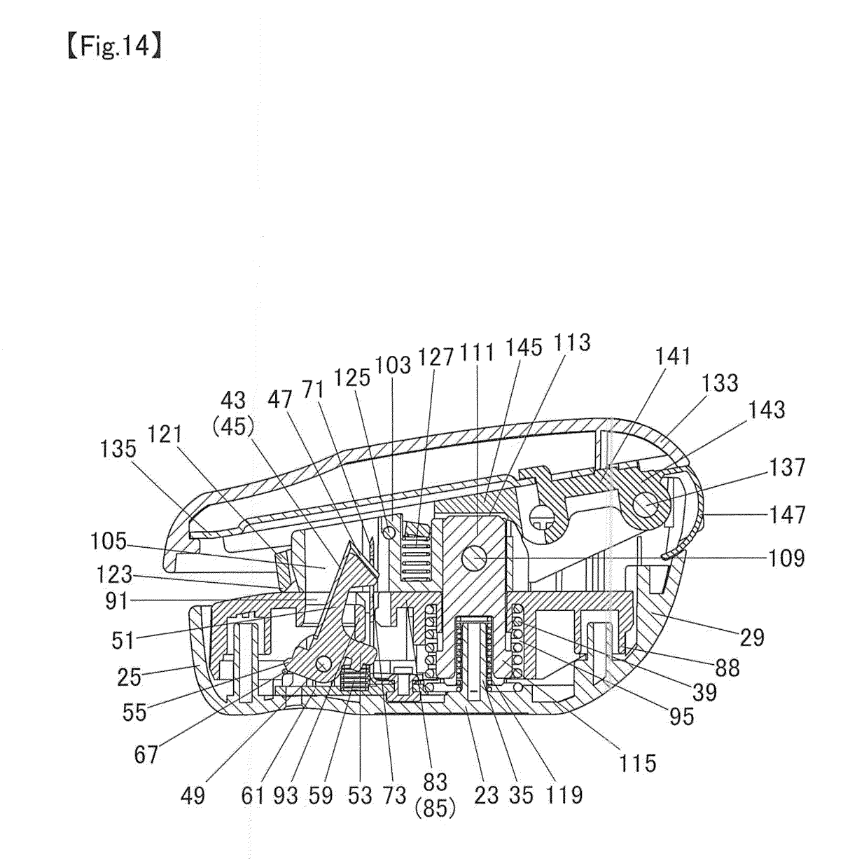

When the placing table 81 is lowered further, the pressing-down portion 93 is brought into contact with an upper surface of the proximal projection 53 of the bending member 51 and then presses down the proximal projection 53, whereby the upper ends of the first cutter 43 and the bending member 51 rotate to the rear. This causes a rear end portion of the distal projection 47 of the first cutter 43 and the bending member 51 to be inserted slightly into the window portion 73 in the second cutter 71 as shown in FIG. 14, whereby distal ends 17 of the pieces of tongue-shaped paper 15 are caused to penetrate the window portion 73 in the second cutter 71.

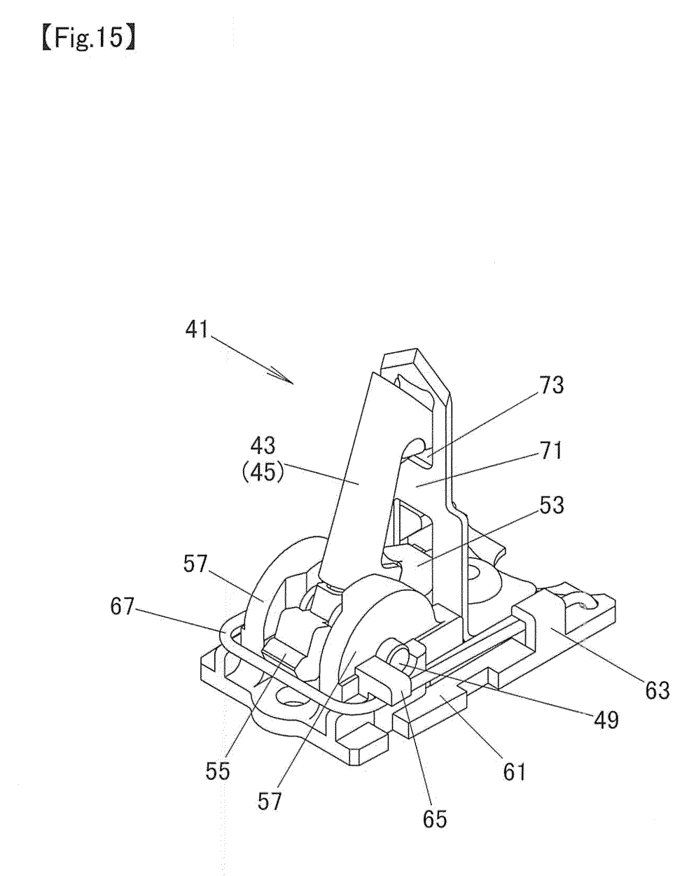

As this occurs, as shown in FIG. 15, the front protuberant portion 55 which is provided at the front of the lower end portion of the bending member 51 is raised as a result of the rotation of the bending member 51. However, the front straight-line portion of the sound generating spring 67 is restricted from moving upwards by the spring restricting portions 65, and the front straight-line portion of the sound generating spring 67 is disengaged from the front protuberant portion 55. Then, a front portion of the sound generating spring 67 is driven against the upper surface of the base plate portion 61 by virtue of the elastic force thereof to thereby vibrate the base plate portion 61 slightly while generating a striking sound.

Thereafter, when the force with which the fastening tool 20 is held by the hand is mitigated to reduce the force with which the front end of the handle member 131 is pressed down, the placing table 81 can be raised by virtue of the springback force of the first elastic member 39. Then, the pressing-down portion 92 is raised, and the first cutter 43 and the bending portion 51 can be returned to the vertical state by virtue of the springback force of the return spring 59.

As this occurs, the front protuberant portion 55 rotates downwards and presses down the front straight-line portion of the sound generating spring 67 about the spring fixing portions 63. Then, the front protuberant portion 55 returns to the position lying underneath the sound generating spring 67, and the distal projection 47 of the first cutter 43 is dislocated from the window portion 73 in the second cutter 71. However, the pieces of tongue-shaped paper 15 are in touch with an upper edge of the window portion 73 in a position near distal ends thereof, and the pieces of tongue-shaped paper 15 are kept staying in the state in which the pieces of tongue-shaped paper 15 penetrate the window portion 73.

When the placing table 81 is raised further to position the upper surface of the flat portion 85 higher than the upper ends of the first cutter 43 and the second cutter 71, the distal ends 17 of the pieces of tongue-shaped paper 15 penetrate the linear cuts 13 and are then pulled thereout to lie below the sheets of paper 10 when the second cutter 71 which has caused the pieces of tongue-shaped paper 15 to penetrate the window portion 73 is pulled downwards through the sheets of paper 10 to lie therebelow, whereby the sheets of paper 10 can be fastened together by the pieces of tongue-shaped paper 15 in such a state that the sheets of paper 10 are superposed one on the other or another.

When the front end of the handle member 131 is caused to rotate further upwards, the placing table 81 is prevented from being raised further by lower ends of sliding grooves 99 which are provided so as to be brought into engagement with the sliding projections 37 which are provided on the inner sides of the side wall portions 27 of the base member 21. Thereafter, the paper holding member 101 is raised by virtue of the repulsive force of the second elastic member 119. Then, a gap is formed between the main body portion 103 of the paper holding member 101 and the flat portion 85 of the placing table 81, and the rising of the paper holding member 101 is prevented by the collar portion 115, whereby the sheets of paper 10 that are now fastened together can be removed from the fastening tool 20.

Then, when the force with which the handle member 131 is held is released, the front end of the handle member 131 is rotated upwards by the elastic portion 147, and the handle member 131 is stopped so rotating in a position where the pressing portion 145 is spaced slightly apart from the upper end face 113 of the sliding shaft 111 and can be maintained in that position. Thus, the fastening tool 20 is returned to the initial state thereof.

In addition, a configuration may be adopted in which the sound generating spring 67 is omitted, and instead, an outwardly projecting linear projecting portion 169 is provided near the distal end of the elastic portion 147 which is provided at the rear of the base member 141, and a latch pin 161 is provided in the rear wall portion 29 of the base member 21.

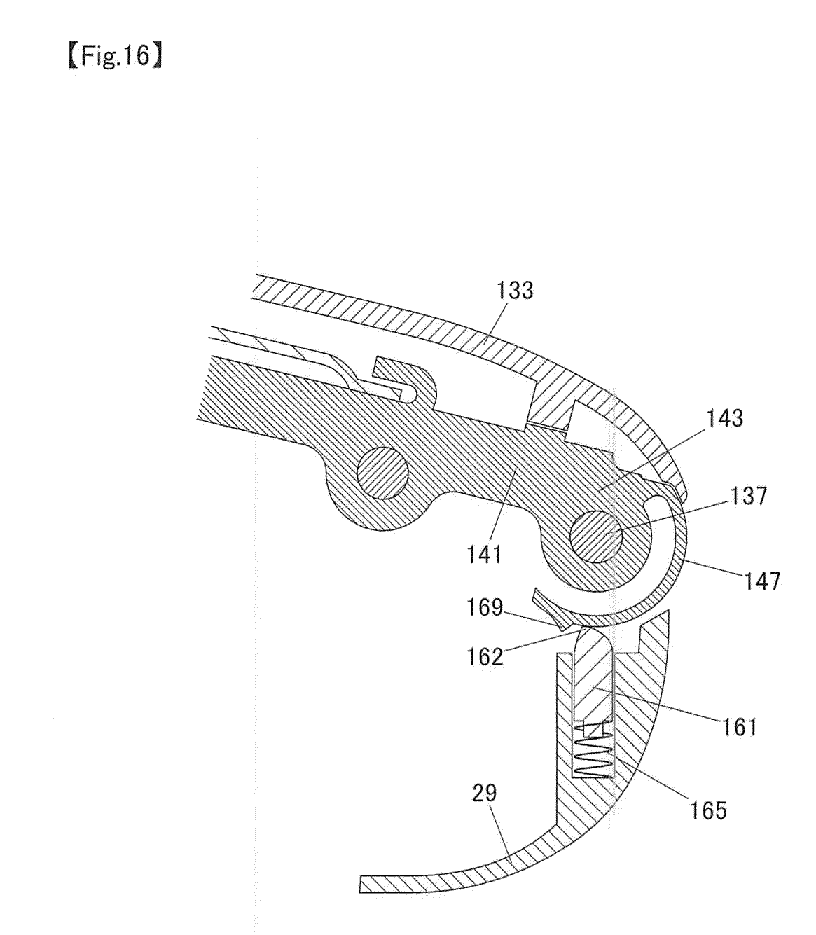

In this modified example, as shown in FIG. 16, a void is formed in the rear wall portion 29 of the base member 21, and the latch pin 161 and a latch spring 165 are accommodated in the void. Then, a distal end 162 of the latch pin 161 is brought into press contact with the elastic portion 147, and the linear projecting portion 169 is formed on an outer circumferential surface of the portion of the elastic portion 147 which lies near the distal end thereof.

This linear projecting portion 169 is formed on the outer circumferential surface of the curved elastic portion 147 as a linear portion which is parallel to the handle shaft 137. A front and rear sides of the distal end 162 of the latch pin 161 are formed into a curved inclined surface.

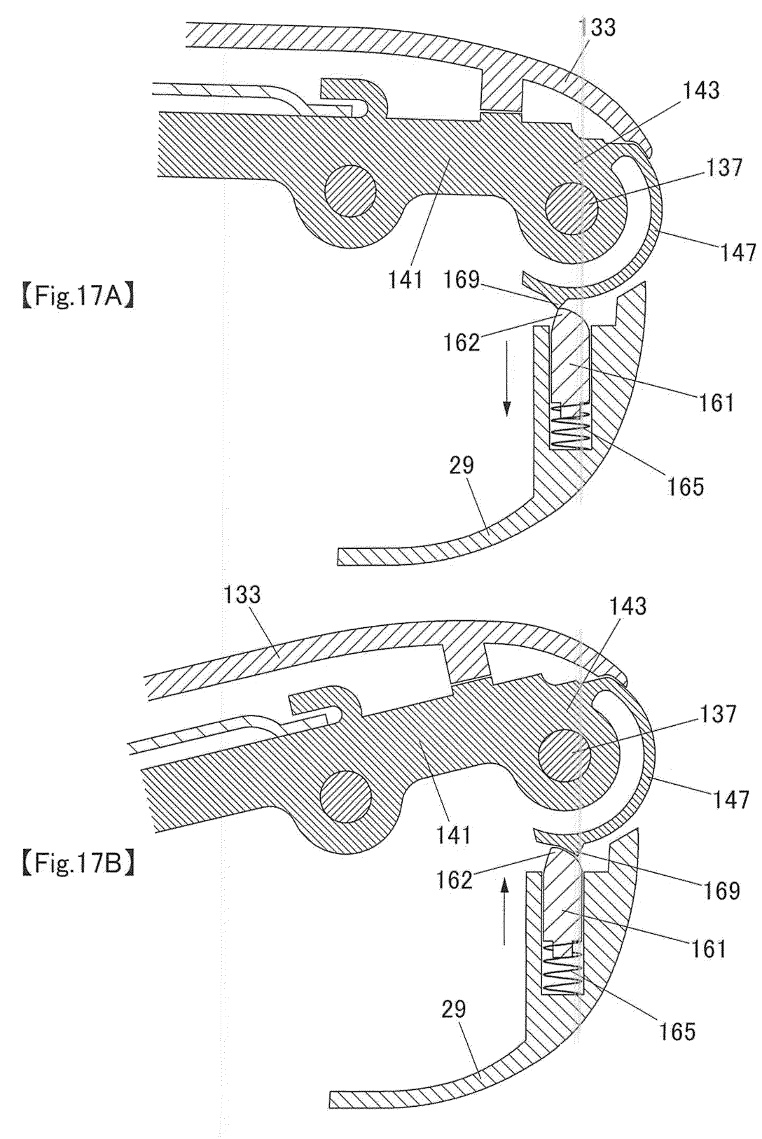

In this modified example, when the front end of the handle member 131 is lowered to thereby rotate the base member 141 including the bearing portions 143 or the elastic portion 147, which is provided at the rear end of the base member 141 so as to extend downwards, about the handle shaft 137, as shown in FIG. 17A, the curved shape of the elastic portion 147 is slightly distorted, and the latch pin 161 is lowered while compressing the latch spring 165. Then, when the linear projecting portion 169 on the elastic portion 147 rides over the distal end 162 of the latch pin 161, as shown in FIG. 17B, the distortion of the elastic portion 147 is released and the elastic portion 147 restores its initial curved shape. At the same time, the latch pin 161 is allowed to rise quickly, allowing the distal end 162 of the latch pin 161 to strike the outer circumferential surface of a curved main body of the elastic portion 147, whereby a striking sound is generated while causing the user to feel a slight latching sensation.

Then, when the front end of the handle member 131 is allowed to rise by mitigating the force with which the fastening tool 20 is held by the hand, the distal end of the elastic portion 147 is rotated to the front so that the linear projecting portion 169 rides over the distal end 162 of the latch pin 161 from the rear inclined surface of the latch pin 161, whereby the latch pin 161 and the elastic portion 147 are returned to their initial states shown in FIG. 16.

In this way, the fastening tool 20 according to the embodiment of the invention has the construction in which the placing table 81, which is allowed to move only in the vertical direction, is provided at the inner upper portion of the base member 21, the paper holding member 101, which is allowed to move in the vertical direction, is disposed above the placing table 81, and the handle member 131 is mounted on the base member 21 so as to rotate relative to the base member 21 about the position lying near the rear end thereof In addition, the fastening tool 20 according to the embodiment of the invention has such a cam construction as directly pressing down a rear upper surface of the paper holding member 101 by the pressing portion 145 of the handle member 131. Therefore, the construction of the fastening tool 20 is made simple, thereby facilitating the fabrication of the fastening tool 20. Further, the pressing portion 145 is provided on the handle member 131 in the position which lies further rearwards than the center thereof, and as a result of that, the cam construction enables the paper holding member 101 and the placing table 81 to be lowered with the small force.

In addition, the use of metallic members is limited to a minimum level or to the handle plate 135, the first cutter 43 and the second cutter 71, and the elastic members. The handle cover 133, the paper holding member 101, the placing table 81 and the base member 21 are made of resin to reduce the weight of the fastening tool 20, thereby facilitating the handling of the fastening tool 20 by a single hand.

Further, the front protuberant portion 55 is provided at the base portion of the first cutter 43 for engagement with the sound generating spring 67. Then, when the upper end of the first cutter 43 is rotated, the engagement of the front protuberant portion 55 with the sound generating spring 67 is released, whereby the sound generating spring 67 is driven against the upper surface of the base plate portion 61 by virtue of the elastic force thereof to thereby vibrate the base plate portion 61 slightly while generating a striking sound. Therefore, the user can be informed that the sheets of paper 10 are fastened together by the pieces of tongue-shaped paper 15.

It should be noted that the user can be informed in a similar way that the sheets of paper 10 are fastened together by the pieces of tongue-shaped paper 15 also when the linear projecting portion 169 is provided on the elastic portion 147 and the latch pin 161 is accommodated in the rear wall portion 29, in place of providing the sound generating spring 67 at the base portion of the first cutter 43.

Additionally, the cutter member 41 adopts such a construction as the first cutter 43 being mounted on the base plate portion 61 together with the second cutter 71 as a unit. Therefore, it is possible to facilitate the incorporation of the cutters for forming the linear cuts 13 and the pieces of tongue-shaped paper 15 in the sheets of paper, which make up the main part of the fastening tool 20.

It should be noted that a configuration may be adopted in which small circular openings are provided in the side wall portions 27 so that red marks are, for example, visible from the openings when the handle member 131 is pressed down to reach its lowest position. Thus, the red marks may be an indicator that indicates the completion of a fastening operation.

Alternatively, a configuration may be adopted in which needles or needle marks are provided at upper portions of the side suspended walls 87 of the placing table 81 so that the needles are positioned near an upper end of the front wall portion 25 when the handle member 131 is pressed down to reach its lowest position. Thus, the appearance of the needles near the upper end of the front wall portion 26 may be an indicator that indicates the completion of a fastening operation.

Thus, as has been described heretofore, according to the fastening tool 20 according to the embodiment of the invention, sheets of paper 10 which are superposed one on the other or another are punched out partially and the partially punched out portions are folded back so that the sheets of paper 10 can be fastened together in such a state that the sheets of paper 10 are superposed one on the other or another without using a metallic staple or staples. Thus, materials prepared in this way can facilitate the disposal thereof when they are disposed of Additionally, the fastening tool 20 can also be handled easily by a single hand.

What is claimed is:

1. A fastening tool having a first cutter for forming pieces of tongue-shaped paper in sheets of paper and a second cutter for forming linear cuts in the sheets of paper, in which the pieces of tongue-shaped paper are formed through U-shaped cut lines made by the first cutter and the linear cuts are formed near base portions of the pieces of tongue-shaped paper by the second cutter, and the pieces of tongue-shaped paper are folded back so that distal ends of the pieces of tongue-shaped paper are inserted into the linear cuts to fasten the sheets of paper that are superposed one on the other or another together, the fastening tool comprising:
a base member having a wall portion which is raised from a periphery of a bottom plate having a flat plate shape; and a handle member which is mounted on a rear upper portion of the base member so as to rotate about a position lying near a rear end thereof, wherein a pressing portion is provided on the handle member which forms a cam construction to press down a paper holding member.

2. A fastening tool according to claim 1, wherein
a projecting portion is provided further on the handle member for engagement with a slit provided in the paper holding member.

3. A fastening tool according to claim 2, wherein
a tensioning plate spring is provided further on the handle member which operates so as to press against the paper holding member.

4. A fastening plate according to claim 3, wherein
the pressing portion and the tensioning plate spring are provided on a base member which is integrated with the handle member.

5. A fastening tool having a first cutter for forming pieces of tongue-shaped paper in sheets of paper and a second cutter for forming linear cuts in the sheets of paper, in which the pieces of tongue-shaped paper are formed through U-shaped cut lines made by the first cutter and the linear cuts are formed near base portions of the pieces of tongue-shaped paper by the second cutter, and the pieces of tongue-shaped paper are folded back so that distal ends of the pieces of tongue-shaped paper are inserted into the linear cuts to fasten the sheets of paper that are superposed one on the other or another, the fastening tool comprising:
a base member having a wall portion which is raised from a periphery of a bottom plate having a flat plate shape; a handle member which is mounted on a rear upper portion of the base member so as to rotate about a position lying near a rear end thereof; and
a placing table configured so as to slide vertically and which is provided at an inner upper portion of the base member, wherein the first cutter and the second cutter are accommodated below the placing table; and
a paper holding member configured so as to slide vertically and which is provided above the placing table, wherein an upper surface of a portion of the paper holding member which lies near a rear end thereof is pressed down by a portion of the handle member which lies inside and further rearwards than a center of the handle member so as to lower the paper holding member; wherein
sheets of paper held between the placing table and the paper holding member are lowered together with the paper holding member and the placing table so that cuts are provided in the sheets of paper so held by the first cutter and the second cutter to thereby fasten the sheets of paper together, and wherein
the base member, the handle member, the placing table and the paper holding member are formed of resin, and a metallic plate formed into a plate shape is provided in an interior of the handle member.
